(19) United States
(12) Patent Application Publication
(10) Pub. No.: US 2026/0238505 A1
(43) Pub. Date: Aug. 13, 2026

(54) METHOD FOR TRANSMITTING INFORMATION BY WAY OF A 2-WIRE MEASURING DEVICE

(71) Applicant: Endress+Hauser SE+Co. KG, Maulburg (DE)

(72) Inventors: Lars Karweck, Binzen (DE); Volker Frey, Schopfheim (DE); Alexander Vogel, Kirchzarten (DE); Sascha D'Angelico, Rümmingen (DE); Tanja Haag, Schopfheim (DE); Alexey Malinovskiy, Maulburg (DE); Christoph Schmitt, Schopfheim (DE); Nicolas Schönborn, Rietberg (DE)

(21) Appl. No.: 19/138,151

(22) PCT Filed: Nov. 30, 2023
(86) PCT No.: PCT/EP2023/083757

§ 371 Date: Jun. 12, 2025

(30) Foreign Application Priority Data
Dec. 16, 2022 (DE) 10 2022 133 731.6

(51) Int. Cl. H04L 12/12

(52) U.S. Cl. CPC H04L 12/12

(57) ABSTRACT

The present disclosure relates to a method for information transmission by means of a 2-conductor measuring device having a communication unit for transmitting at least one piece of information to a superordinated unit, comprising method steps of providing the at least one piece of information with a time stamp and an address, and transmitting a measurement vector comprising at least the at least one piece of information, a time stamp and an address of the measuring device to the superordinated unit by means of the communication unit.

The invention relates to a method, especially a computer implemented method, for information transmission by means of a 2-conductor measuring device.

Measuring devices in process and automation technology serve for monitoring and/or determining at least one process variable of a medium, for example a chemical or physical, process variable. In the context of the invention, in principle, all field devices are referred to as measuring devices, when they are applied near to a process and deliver, or process, process relevant information. A large number of such measuring devices are manufactured and sold by the Endress+Hauser group of companies.

The process variable to be determined by the measuring device can be the fill level, the flow, the pressure, the temperature, the pH value, a redox potential, or the conductivity of the medium. The different, possible measuring principles underpinning the determining of the process variable are known in the state of the art and are, in such case, not further explained. Measuring devices for measuring fill level are embodied, especially, as microwave, fill level measuring devices, ultrasonic, fill level measuring devices, time domain reflectometric, fill level measuring devices (TDR), radiometric, fill level measuring devices, capacitive, fill level measuring devices, conductive, fill level measuring devices and vibronic, fill level measuring devices. Measuring devices for measuring flow work, in contrast, for example, according to the Coriolis-, ultrasonic-, vortex-, thermal and/or magnetically inductive measuring principles. In the case of pressure measuring devices, there are absolute-, relative- and difference pressure measuring devices.

A measuring device typically includes a sensor coming, at least partially, and/or at least at times, in contact with the process, and an electronics unit, which serves, for example, for signal registration, signal evaluation and/or signal feeding. The electronics unit of the measuring device is typically arranged in a housing and has, supplementally, at least one connecting element for connecting of the electronics unit to the sensor and/or to an external unit and for transferring data and/or energy.

Measuring devices can be connected via a two-wire line, i.e. a line with two separately formed leads, to a superordinated unit, such as, for example, a control unit or a control system. The measured values of the sensors are communicated to the superordinated unit analogly as a 4-20 mA electrical current signal. The energy supply of the measuring devices can occur likewise via the two-wire line. However, the energy available in such a way is quite limited. If a measuring device needs more energy than can be provided via the two-wire line, then, for example, three-or four-wire lines are used.

In conventional process environments, measuring devices are embodied as slaves and are cyclically queried by a master, which, frequently, is a superordinated unit. After the corresponding query by the master, the measuring device transmits its measurement data or other information to the master. The cyclic retrieval of the data from the measuring device by the master determines, in such case, the order and time structuring of the data received by the master. The measuring device itself sends no time related information to the master.

An object of the invention is, consequently, to provide a method having an improved information transfer between a measuring device and a superordinated unit.

As regards the method, the object of the invention is achieved by a method, especially a computer implemented method, for information transmission by means of a 2-conductor measuring device having a communication unit for transmitting at least one piece of information to a superordinated unit, comprising method steps as follows:
providing the at least one piece of information with a time stamp and an address, and
transmitting a measurement vector comprising the at least one piece of information, the time stamp and an address of the measuring device to the superordinated unit by means of the communication unit.

In the method of the invention, the measuring device acts as master and is able to transmit information to the superordinated unit by means of the communication unit. In order that the at least one piece of information in the superordinated unit can be properly classified, the at least one piece of information is provided with a time stamp and an address. Based on the address of the measuring device, the superordinated unit can identify the measuring device. Based on the time stamp, the measurement vector transmitted to the superordinated unit can be time sorted. This facilitates structuring of the many pieces of information (among others, from other measuring devices) transmitted to the superordinated unit.

In an embodiment, the measurement vector is transmitted by means of the NAMUR-Open-Architecture. The NAMUR-Open-Architecture (NOA) offers a standardized information model, which enables a secure transmitting of information from the process environment, in this case from the measuring device, to the superordinated unit.

In an additional embodiment, an IP-address is associated with the measuring device. By means of the IP-address, an automatic accessing of the measuring device is possible.

Another embodiment provides that information transmission is performed at predeterminable points in time, especially cyclically. The predeterminable points in time can depend, for example, on a frequency of registering of the at least one piece of information by the measuring device.

In a further development of the method, an information time is ascertained, which corresponds to a registering point in time for registering the at least one piece of information by means of the measuring device. In the case, in which the piece of information is a measured value, the registration time is, for example, a measurement point in time, thus, the point in time, at which the measured value was registered. The information time can facilitate the time sorting of the measurement vector in the superordinated unit.

Preferably, a reference time is registered relative to the plant time, factory time or time of the superordinated unit. In many cases in a plant or a factory, a reference time is predetermined by a master, especially by the superordinated unit.

Preferably, the information time is compared with the reference time, wherein, for example, a time synchronization is performed. Over time, deviations between the information time, thus, a time present in the measuring device, and the reference time, can occur. If the superordinated unit detects based on comparison of information time with reference time that a deviation is present, then it can cause a time synchronization of the measuring device to occur. The time synchronization is a matching of the information time to the reference time in the measuring device. Alternatively, the superordinated unit can be embodied, to transmit, in given cases, cyclically, the reference time to the measuring device. In such case, the measuring device can detect, whether a difference between the information time and the reference time is present and, when necessary, perform a time synchronization.

In an embodiment, a transmission time is registered corresponding to a transmission point in time of the at least one piece of information. The transmission time corresponds to the transmission point in time of the at least one piece of information, thus that point in time, at which the measurement vector is transmitted with the at least one piece of information from the measuring device to the superordinated unit. The transmission time stands opposite a receipt time, which corresponds to a point in time of receipt of the at least one piece of information by the superordinated unit.

In an additional embodiment, used as time stamp is at least the measurement time, a time difference between the measurement time and the reference time, the transmission time and/or a dead time, which is a time difference between the measurement time and the transmission time.

In a further development, the method further comprises additional steps as follows:
transmitting a plurality of measurement vectors to the superordinated unit at predeterminable transmission points in time, wherein, in each case, first and second measurement vectors form a measurement vector pair and the second measurement vector is transmitted at a defined length of time after the first measurement vector,
storing the receipt points in time of the measurement vectors by the superordinated unit,
ascertaining a travel time and/or an uncertainty of the travel time between the communication unit and the superordinated unit based on the transmission points in time and the receipt points in time of the measurement vectors.

Based on, especially a comparison of, the transmission points in time and the receipt points in time of the measurement vectors, a travel time between the communication unit of the measuring device and the superordinated unit can be ascertained. The travel time is also known as latency. Usually, the latency has a so-called jitter, an uncertainty, which is caused by an irregular time delay when transmitting between the measuring device and the superordinated unit.

An embodiment provides that the address of the measuring device is provided by a measurement location for registering the at least one piece of information. The measurement location is especially the site, where the measuring device is arranged.

Preferably, the at least one piece of information is a measured value.

In an embodiment, the measurement vector includes a measurement uncertainty relative to the measured value, the measurement time and/or the measurement location.

As regards the computer program, the object is achieved according to the invention by a computer program for determining at least one process variable of a medium and containing computer readable, program code elements, which, when executed by a computer, cause the computer to perform a method according to at least one of the preceding embodiments.

As regards the computer program product, the object is further achieved by a computer program product having a computer program of the preceding embodiment and at least one computer readable medium, in which at least the computer program is stored.

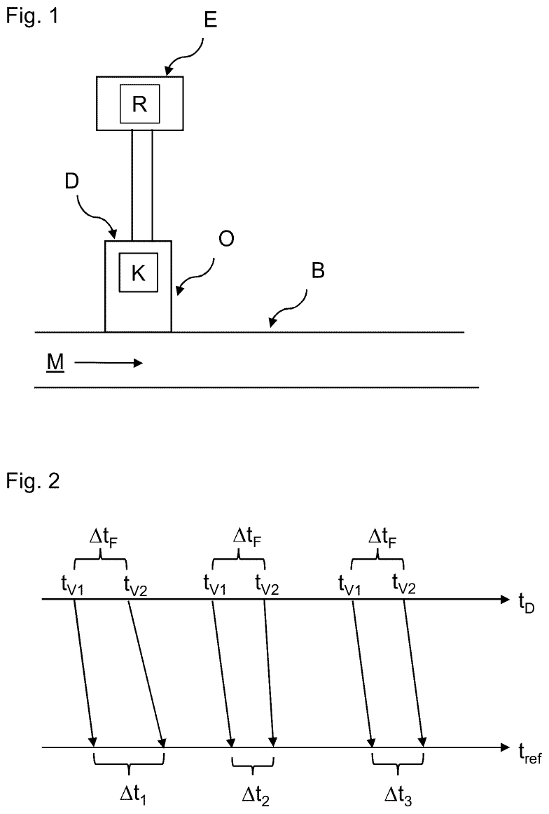

The invention will now be explained in greater detail based on the appended drawing, the FIGS. 1-2 of which show as follows:

FIG. 1 a schematic view of a measuring device and a superordinated unit.

FIG. 2 a schematic view of the cyclic transmission of measurement vector pairs.

The method of the invention is usable for all types of measuring devices, of which a non limiting selection is given above.

FIG. 1 shows a measuring device D, which is connected with a superordinated unit S by means of a 2-wire line. Measuring device D includes a communication unit K, which is adapted to transmit information to the superordinated unit S and to receive information from the superordinated unit S. The measuring device D is mounted at a measurement location L on a containment, in FIG. 1, a pipe P, in which a medium M is located.

Especially, the measuring device D is adapted to determine and/or to monitor at least one process variable of the medium. In given cases, the superordinated unit S can have a computing unit C, which is embodied for transmitting, receiving and processing information.

In the method of the invention, in a first method step, at least one piece of information is provided with a time stamp and an address of the measuring device D. The address of the measuring device D can be given by the measurement location L, where the at least one piece of information was registered. Alternatively or supplementally, an IP-address can be associated with the measuring device D. The time stamp is especially the measurement time, a time difference between the measurement time and the reference time, the transmission time and/or a dead time, which is a time difference between the measurement time and the transmission time. The at least one piece of information can be, for example, a measured value of the measuring device D. The at least one piece of information, the time stamp and the address of the measuring device D form a measurement vector, which optionally includes a measurement uncertainty relative to the measured value, the measurement time and/or the measurement location L.

In a second method step, the measurement vector is transmitted by means of the communication unit K to the superordinated unit S. For example, the NAMUR-Open-Architecture can be used for the transmitting. The transmitting of the measurement vector is especially performed at predeterminable points in time.

In an additional method step, an information time can be ascertained, which corresponds to a registering point in time for registering the at least one piece of information by means of the measuring device D. In another optional method step, a reference time is registered relative to the plant time, factory time, time of the superordinated unit S. Furthermore, a transmission time can be registered, which corresponds to a transmission point in time of the at least one piece of information. This supplementally registered information, i.e. the information time, the reference time and/or the transmission time, can be applied in order to improve the time classification of the at least one piece of information in the superordinated unit. In given cases, information time can be compared with its reference time and a time synchronization performed.

Based on a measurement vector pair, additionally, the travel time and/or an uncertainty of the travel time between the communication unit K and the superordinated unit S can be ascertained. For this, several measurement vectors are transmitted to the superordinated unit S by means of the communication unit K. Between the transmitting of each first and second measurement vectors, a defined length of time is set, which can be stored especially in the measuring device D and in the superordinated unit S. In each case, the length of time between the transmission of the second measurement vector and the first measurement vector can vary or be defined.

This optional method is shown schematically in FIG. 2. The upper time axis to shows the time axis of the measuring device D, while the lower axis represents the time axis of the superordinated unit S. In this example, that is the time axis of the reference time t_{ref}. The measuring device D transmits by means of the communication unit K a plurality of measurement vectors to the superordinated unit S at transmission points in time t_{Vn}. In such case, in each case, a first measurement vector and a second measurement vector form a measurement vector pair, whose particular transmission points in time t_{V1} and t_{V2}are separated by a defined length of time Δt_{F}. The length of time between the measurement vector pairs, thus, between t_{V2} and t_{V1}, can, in such case, vary or be cyclic. The arrows in FIG. 2 associate the transmission points in time t_{Vn} of the measurement vectors with their points in time of receipt t_{ref} by the superordinated unit S. Based on the transmission points in time t_{Vn} and the receipt points in time t_{ref}, finally, the travel time and/or an uncertainty of the travel time between the communication unit K and the superordinated unit S can be ascertained. This is performed especially based on a statistical comparison of the time intervals Δt_{1, 2, 3, . . .} of the receipt points in time t_{ref} between the, in each case, first and second measurement vectors of the measurement vector pairs.

### LIST OF REFERENCE CHARACTERS

D measuring device
K communication unit
S superordinated unit
M medium
P containment, pipe
C computing unit
L measurement location

1-15. (canceled)

16. A method for information transmission using a 2-conductor measuring device having a communication unit for transmitting at least one piece of information to a superordinated unit, comprising the following method steps:
providing the at least one piece of information with a time stamp and an address, and
transmitting a measurement vector comprising the at least at least one piece of information, the time stamp and an address of the measuring device to the superordinated unit by means of the communication unit.

17. The method of claim 16,
wherein the measurement vector is transmitted using the NAMUR-Open-Architecture.

18. The method of claim 16,
wherein an IP-address is associated with the measuring device.

19. The method of claim 16,
wherein information transmission is performed cyclically.

20. The method of claim 16,
wherein an information time is ascertained, which corresponds to a registering point in time for registering the at least one piece of information by means of the measuring device.

21. The method of claim 16,
wherein a reference time is registered relative to the plant time, factory time, time of the superordinated unit.

22. The method of claim 20,
wherein information time is compared with its reference time, wherein a time synchronization is performed.

23. The method of claim 16,
wherein a transmission time is registered corresponding to a transmission point in time of the at least one piece of information.

24. The method of claim 16,
wherein used as time stamp is at least the measurement time, a time difference between the measurement time and the reference time, the transmission time and/or a dead time, which is a time difference between the measurement time and the transmission time.

25. The method of claim 16,
wherein the method further comprises additional steps as follows:
transmitting a plurality of measurement vectors to the superordinated unit at predeterminable transmission points in time, wherein, in each case, first and second measurement vectors form a measurement vector pair and the second measurement vector is transmitted at a defined length of time after the first measurement vector,
storing the receipt points in time of the measurement vectors by the superordinated unit,
ascertaining a travel time and/or an uncertainty of the travel time between the communication unit and the superordinated unit based on the transmission points in time and the receipt points in time of the measurement vectors.

26. The method of claim 16,
wherein the address of the measuring device is provided by a measurement location for registering the at least one piece of information.

27. The method of claim 16,
wherein the at least one piece of information is a measured value.

28. The method of claim 26,
wherein the measurement vector includes a measurement uncertainty relative to the measured value, the measurement time and/or the measurement location.

29. A computer program for determining at least one process variable of a medium and containing computer readable, program code elements, which, when executed by a computer, cause the computer to perform a method including the following steps:
providing the at least one piece of information with a time stamp and an address, and
transmitting a measurement vector comprising the at least at least one piece of information, the time stamp and an address of the measuring device to the superordinated unit by means of the communication unit.

30. The computer program product having a computer program as claimed in claim 29 and at least one computer readable medium, in which at least one computer program is stored.
